(19) United States
(12) Patent Application Publication
(10) Pub. No.: US 2025/0254502 A1
(43) Pub. Date: Aug. 7, 2025

(54) SYSTEMS AND METHODS FOR DISTRIBUTED MACHINE LEARNING WITH LESS VEHICLE ENERGY AND INFRASTRUCTURE COST

(71) Applicant: Toyota Motor Engineering & Manufacturing North America, Inc., Plano, TX (US)

(72) Inventors: Chianing Wang, Mountain View, CA (US); Haoxiang Yu, Austin, TX (US); Evan King, Austin, TX (US); Alexander T. Pham, San Jose, CA (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/434,024

(22) Filed: Feb. 6, 2024

(51) Int. Cl. H04W 4/44; H04W 4/02

(52) U.S. Cl. CPC H04W 4/44; H04W 4/027

(57) ABSTRACT

A method for updating a machine learning model for vehicles is provided. The method includes calculating a benefit score for each of a pair of vehicles based on an energy for training a machine learning model and a value of training data, selecting one of the pair of vehicles having a higher benefit score as a trainer for training the machine learning model, aggregating, by the trainer, the machine learning models of the pair of vehicles, calculating an edge encounter score for each of the pair of vehicles, selecting one of the pair of vehicles having a higher edge encounter score as a representer, and uploading, by the representer, the aggregated machine learning model to an edge server.

### TECHNICAL FIELD

The present disclosure relates to systems and methods for distributed machine learning among connected vehicles, more specifically, to systems and methods for distributed machine learning that requires less vehicle energies and infrastructure costs.

### BACKGROUND

Traditional machine learning is centralized and needs lots of infrastructure resource to support training. Distributed learning methods include decentralized learning and federated learning. The federated learning is a method where clients, e.g., vehicles train a model locally and upload the model to a central server, and the central sever aggregates the trained models from edge devices and sends the aggregated model back to the clients. On the other hand, decentralized learning involves distributing the training process across multiple clients such as vehicles or edge devices such as road-side devices that are connected in a peer-to-peer network. Each client processes a portion of the data and communicates with other clients to share information.

Federated learning requires lots of communication among vehicles, edge servers, and a central server for updating a machine learning model. Whereas decentralized learning does not rely on a central server. Decentralized learning requires that each vehicle identify the locations of other vehicles, edge servers, and other components. However, conventional decentralized learning does not consider energy consumption for training a machine learning model and the cost of offloading aggregated models to an edge server.

Accordingly, a need exists for systems and methods for reducing vehicle energies and infrastructure costs for decentralized learning.

### SUMMARY

The present disclosure provides systems and methods for distributed machine learning that utilizes edge encounter scores (EES) and energy-balanced client selections (EBCS).

In one embodiment, a method for updating a machine learning model for vehicles is provided. The method includes calculating a benefit score for each of a pair of vehicles based on an energy for training a machine learning model and a value of training data, selecting one of the pair of vehicles having a higher benefit score as a trainer for training the machine learning model, aggregating, by the trainer, the machine learning models of the pair of vehicles, calculating an edge encounter score for each of the pair of vehicles, selecting one of the pair of vehicles having a higher edge encounter score as a representer, and uploading, by the representer, the aggregated machine learning model to an edge server.

In another embodiment, a system for updating a machine learning model for vehicles is provided. The system includes a first vehicle comprising a first machine learning model and one or more processors, and a second vehicle comprising a second machine learning model. The one or more processors are programmed to calculate a benefit score for the first vehicle based on an energy for training a machine learning model and a value of training data and obtain a benefit score for the second vehicle, determine the first vehicle as a trainer for training the machine learning model based on a comparison of benefit scores of the first vehicle and the second vehicle, aggregate the machine learning models of the first vehicle and the second vehicle, calculate an edge encounter score for the first vehicle and obtain an edge encounter score for the second vehicle, select one of the first vehicle and the second vehicle having a higher edge encounter score as a representer, and instruct the representer to update the aggregated machine learning model to an edge server.

In another embodiment, a non-transitory computer readable medium storing instructions is provided. The instructions, when executed by one or more processors of a first vehicle, cause the one or more processors to: calculate a benefit score for the first vehicle based on an energy for training a machine learning model and a value of training data and obtain a benefit score for a second vehicle; determine the first vehicle as a trainer for training the machine learning model based on a comparison of benefit scores of the first vehicle and the second vehicle; aggregate the machine learning models of the first vehicle and the second vehicle; calculate an edge encounter score for the first vehicle and obtain an edge encounter score for the second vehicle; select one of the first vehicle and the second vehicle having a higher edge encounter score as a representer; and instruct the representer to update the aggregated machine learning model to an edge server.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1A schematically depict federated learning through a decentralized learning approach among a plurality of vehicles present in an area, in accordance with one or more embodiments shown and described herewith;

FIG. 1B schematically depicts determining a trainer and a representer between a pair of vehicles, according to one or more embodiments shown and described herewith;

FIGS. 1C and 1D schematically depict federated learning through a decentralized learning approach among a plurality of vehicles present in an area, in accordance with one or more embodiments shown and described herewith;

FIG. 1E depicts comparison of the present system with conventional systems;

FIG. 2 depicts a schematic diagram of a system for decentralized machine learning, according to one or more embodiments shown and described herein;

FIG. 3 depicts a flowchart for selecting a vehicle for training models and a vehicle for transmitting an aggregated model to an edge server between a pair of vehicles for decentralized machine learning, according to one or more embodiments shown and described herein;

FIG. 4A depicts comparing values of datasets between a pair of vehicles, according to one or more embodiments shown and described herein;

FIG. 4B depicts comparing benefit scores among vehicles, according to one or more embodiments shown and described herein;

FIG. 5 depicts an exemplary scenario where a vehicle calculates an edge encounter score, according to one or more embodiments shown and described herein;

FIG. 6 depicts another exemplary scenario where a vehicle calculates an edge encounter score, according to another embodiments shown and described herein;

FIG. 7A depicts a comparison of energy consumption between a model that utilizes an edge encounter score only and a model that utilizes an edge encounter score and an energy-balanced client selection;

FIG. 7B depicts a comparison of model accuracy between a model that utilizes an edge encounter score only and a model that utilizes an edge encounter score and an energy-balanced client selection; and

FIG. 8 depicts simulation result of message receptions rates, according to one or more embodiments shown and described herein.

### DETAILED DESCRIPTION

The embodiments disclosed herein include systems and methods for decentralized machine learning (DML). In DML, vehicles collect data and perform training using their on-board computers, which reduces the need for the computing by an edge server or a cloud server. The DML training is coordinated by edge servers or mobile edge computers (MEC), which are roadside devices that wirelessly communicate with nearby vehicles and instruct the vehicles when to perform training using the vehicles' processors and data. These MECs periodically receive updates to the DML model from the vehicles that have contributed to training the DML model.

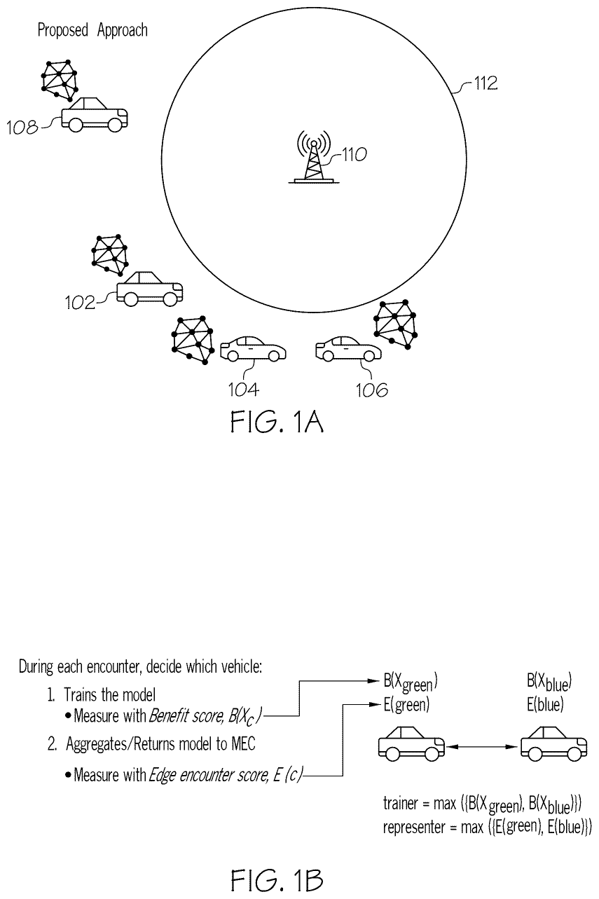

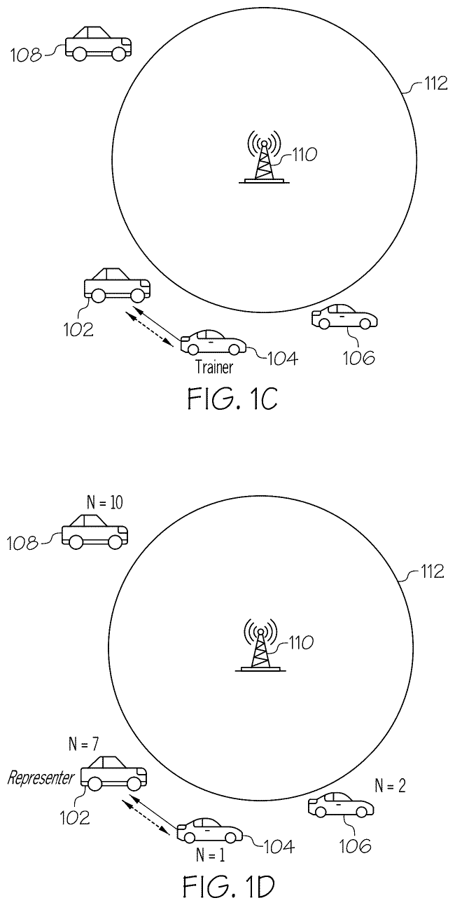

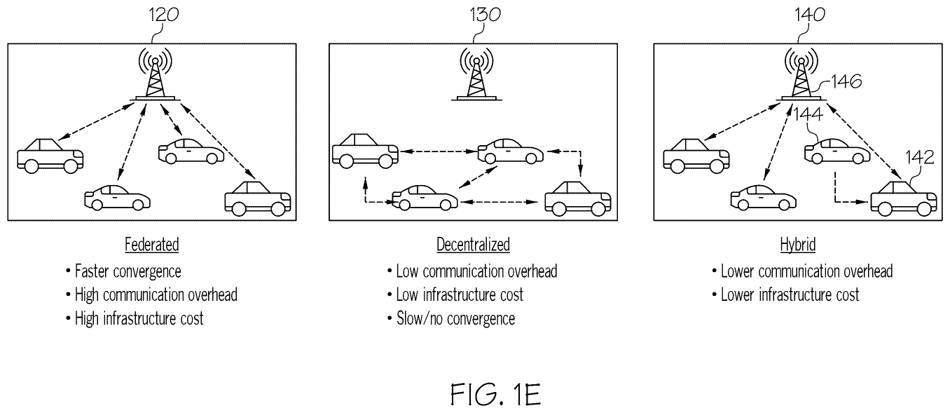

The DML architectures reduce cloud infrastructure cost because data storage and training stays on vehicles. In addition, the DML architectures reduce cloud infrastructure cost because the cloud server is connected to a relatively small number of MECs that coordinate training across many surrounding vehicles. A hybrid DML architecture combines the concept of federated learning and decentralized machine learning, as illustrated in FIG. 1E. The hybrid DML architecture significantly reduces cloud infrastructure costs and improves resource utilization. However, the hybrid DML introduces a new cost of wide-scale MEC deployment and negative impacts to battery life due to model training on vehicles.

Regarding the new cost of wide-scale MEC deployment, offloading model aggregation to the edge server requires investment in MECs. The MECs may be roadside computers that are deployed and maintained in certain locales so that they can coordinate model training in a local area. Managing the cost of this deployment is essential in reaping the benefits of DML. The cost of MEC deployment and maintenance should be lower than the alternative cost of scaling a centralized cloud infrastructure. Using fewer roadside MEC clearly entails lower cost since there are fewer units to deploy and maintain. The present disclosure reduces a smaller number of MECs for DML.

Regarding the negative impacts to battery life, training on the vehicle is a computationally heavy task that consumes the vehicle's electrical energy. In battery-powered electric vehicles (BEVs), overall energy consumption is key consideration. BEVs are powered solely by battery. Therefore, all the vehicle's functionality is dependent on the charging level of the battery. Wasteful use of the battery's finite resources results in lower driving range, which is the top priority of current and prospective BEV drivers. Many locales have sparse charging infrastructure which makes range even more important since drivers must go further distances between charges. There is a tradeoff between DML model performance and energy required for training. Broadly speaking, if a DML model is not trained to save energy, the DML model performance does not improve. Conversely, if the DML model is trained constantly, the training uses a lot of energy, but achieves a high-performance model. Furthermore, not all DML training is guaranteed to improve the performance of the DML model. It is highly dependent on the data distribution of the vehicle's on-board data relative to the data that the DML model has been trained on in the past.

According to embodiments of the present disclosure, during each encounter between two vehicles (i.e., when two vehicles come within wireless communication range of one another), the two vehicles decide which vehicle will train the distributed machine learning model and which vehicle will act as a representer and aggregate the results of training to return them to an MEC. The vehicle that can provide a better energy consumption/model performance improvement tradeoff is the trainer, while the vehicle that has a higher likelihood of encountering a MEC in the future is the representer. The trainer trains the model and the representer aggregates the results

The present disclosure reduces the cost of wide-scale deployment and the negative impacts to battery life. Specifically, the present disclosure implements DML with a minimal number of edge computers while providing the highest performance benefit with the lowest energy consumption. The present disclosure integrates edge encounter scores (EES) and energy-balanced client selection (EBCS) to provide hybrid DML at lower infrastructure cost, while consuming less energy on battery electric vehicles. The present disclosure reduces the number of mobile edge computers required for model aggregation and lowers the overall energy consumption of model training at the same time.

FIG. 1A schematically depict federated learning through a decentralized learning approach among a plurality of vehicles present in an area, in accordance with one or more embodiments shown and described herewith.

FIG. 1A depicts a plurality of vehicles 102, 104, 106, 108 near an area 112 covered by an edge server 110. In embodiments, each of the plurality of vehicles 102, 104, 106, 108 may be an automobile or any other passenger or non-passenger vehicle such as, for example, a terrestrial, aquatic, and/or airborne vehicle. Each of the plurality of vehicles 102, 104, 106, 108 may be an autonomous vehicle that navigates its environment with limited human input or without human input. Each of the plurality of vehicles 102, 104, 106, 108 may include actuators for driving the vehicle, such as a motor, an engine, or any other powertrain. Each of the vehicles 102, 104, 106, 108 includes a machine learning model for performing tasks of corresponding vehicle, such as object identification, object classification, and the like.

One or more of the plurality of vehicles 102, 104, 106, 108 are moving toward the area 112 and planning to upload their machine learning models to the edge server 110 or a mobile edge computer (MEC). For example, the vehicle 102 and the vehicle 104 are moving toward the area 112. When the vehicle 102 and the vehicle 104 are close to each other, for example, within a predetermined distance or a communication range, the vehicles 102 and 104 decide which vehicle will act as a trainer that trains and/or aggregates the models of the vehicles 102 and 104 and which vehicle will act as a representer that uploads the aggregated model. The trainer and the representer may be the same vehicle or different vehicles.

FIG. 1B schematically depicts determining a trainer and a representer between a pair of vehicles, according to one or more embodiments shown and described herewith. When two or more vehicles are within a communication range, each of the vehicles calculates a benefit score B (X), and the vehicle that has a highest benefit score becomes a trainer. In embodiments, the edge server 110 receives benefit scores of the vehicles 102 and 104, determines a trainer, and transmits the machine learning model stored in the edge server 110 to the trainer. The trainer trains its machine learning model and aggregates the machine learning models of the vehicles. Then, each of the vehicles calculates an encounter score E (c), and the vehicle that has a highest encounter score becomes a representer. The representer transmits the aggregated machine learning model to an edge server. The details of calculating benefit scores and encounter scores will be described with reference to 4A, 4B, 5, 6 below.

FIGS. 1C and 1D schematically depict federated learning through a decentralized learning approach among a plurality of vehicles present in an area, in accordance with one or more embodiments shown and described herewith.

In FIG. 1C, the vehicle 104 is determined as a trainer, trains the machine learning model of the vehicle 104 and/or the machine learning model of the vehicle 102 and aggregated the machine learning models of the vehicles 102 and 104. The vehicle 102 and the vehicle 104 are moving toward the area 112. Each of the vehicle 102 and the vehicle 104 may calculate its edge encounter score and share the score with each other. In embodiments, the vehicle having a higher edge encounter score is selected as a representer who transmits aggregated machine learning model to the edge server 110. In some embodiments, the representer aggregates machine learning models of the vehicles 102 and 104 and transmits the aggregated machine learning model to the edge server 110. By referring to FIG. 1D, the vehicle 102 has the edge encounter score of 7 and the vehicle 104 has the edge encounter score of 1. Thus, the vehicle 102 is selected as the representer, and collects and aggregates the machine learning models from the vehicle 102 and the vehicle 104. When the vehicle 102 is within a communication range of the edge server 110, the vehicle 102 delivers the aggregated machine learning model to the edge server 110. The edge server 110 collects aggregated machine learning models from the vehicle 102 and other representers and generate a global machine learning model based on the aggregated machine learning models. Then, the edge server 110 may transmit the global machine learning model to the vehicle 102. The vehicle 102 may share the global machine learning model with the vehicle 104. The vehicle 102 may perform tasks using the global machine learning model. For example, the vehicle 102 may autonomously drive using the global machine learning model. With this methodology, the edge server 110 does not need to communicate with the vehicle 104, but needs to communicate with the vehicle 102 only with respect to the machine learning models of the vehicles 102 and 104.

Other vehicles such as the vehicles 106 and 108 may also calculate their edge encounter score. For example, the vehicle 106 has the edge encounter score of 2 and the vehicle 108 has the edge encounter score of 10. Whenever each of the vehicle 106 and the vehicle 108 encounters with another vehicle, they compare its edge encounter score with the edge encounter score of the another vehicle and decides who will be the representer. For example, when the vehicle 102 encounters with the vehicle 108, the vehicle 108 becomes the representer between the vehicles 102 and 108 because the vehicle 108 has a higher edge encounter score. As another example, when the vehicle 102 encounters with the vehicle 106, the vehicle 102 becomes the representer between the vehicles 102 and 106 because the vehicle 102 has a higher edge encounter score.

FIG. 1E depicts comparison of the present system with conventional systems. The system 120 depicts a conventional federated learning system. The conventional federated learning system 120 has the advantage of faster convergence of machine learning models, but requires high communication overhead and a higher infrastructure cost. The system 130 depicts a conventional decentralized learning system. The conventional decentralized learning system 130 requires low communication overhead and low infrastructure cost, but has slow or no convergence of machine learning models. In contrast with the conventional leaning systems, the present system 140 combines the advantages of both federated learning and decentralized learning, i.e., a hybrid decentralized machine learning system. In the present system 140, the vehicle 142 or the vehicle 144 serves a trainer that trains a machine learning model and aggregates the models of the vehicles 142 and 144. The vehicle 142 serves as the representer between the vehicle 142 and the vehicle 144. Even though the vehicle 144 does not communicate directly with the edge server 146, the edge server 146 can still obtain information on the machine learning model of the vehicle 144 from the vehicle 144 via the vehicle 142. The approach of the present system 140 is regarded as the most flexible and feasible for practical implementation.

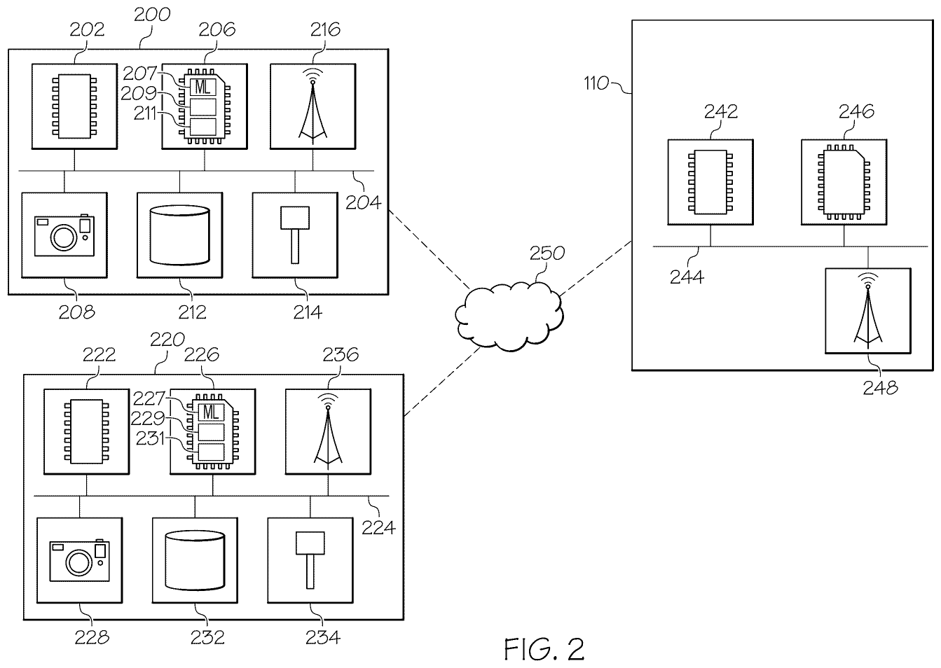

FIG. 2 depicts a schematic diagram of a system for decentralized machine learning, according to one or more embodiments shown and described herein. The system includes a first vehicle system 200 and a second vehicle system 220. In some embodiments, the system may also include an edge server 110. While FIG. 2 depicts two vehicle systems, more than two vehicle systems may communicate with the edge server 110.

It is noted that, while the first vehicle system 200 and the second vehicle system 220 are depicted in isolation, each of the first vehicle system 200 and the second vehicle system 220 may be included within a vehicle in some embodiments, for example, respectively within any two of the vehicles 102, 104, 106, 108 of FIG. 1. In embodiments in which each of the first vehicle system 200 and the second vehicle system 220 is included within an edge node, the edge node may be an automobile or any other passenger or non-passenger vehicle such as, for example, a terrestrial, aquatic, and/or airborne vehicle. In some embodiments, the vehicle is an autonomous vehicle that navigates its environment with limited human input or without human input.

The first vehicle system 200 includes one or more processors 202. Each of the one or more processors 202 may be any device capable of executing machine readable and executable instructions. Accordingly, each of the one or more processors 202 may be a controller, an integrated circuit, a microchip, a computer, or any other computing device. The one or more processors 202 are coupled to a communication path 204 that provides signal interconnectivity between various modules of the system. Accordingly, the communication path 204 may communicatively couple any number of processors 202 with one another, and allow the modules coupled to the communication path 204 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 204 may be formed from any medium that is capable of transmitting a signal such as, for example, conductive wires, conductive traces, optical waveguides, or the like. In some embodiments, the communication path 204 may facilitate the transmission of wireless signals, such as WiFi, Bluetooth®, Near Field Communication (NFC), and the like. Moreover, the communication path 204 may be formed from a combination of mediums capable of transmitting signals. In one embodiment, the communication path 204 comprises a combination of conductive traces, conductive wires, connectors, and buses that cooperate to permit the transmission of electrical data signals to components such as processors, memories, sensors, input devices, output devices, and communication devices. Accordingly, the communication path 204 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The first vehicle system 200 includes one or more memory modules 206 coupled to the communication path 204. The one or more memory modules 206 may comprise RAM, ROM, flash memories, hard drives, or any device capable of storing machine readable and executable instructions such that the machine readable and executable instructions can be accessed by the one or more processors 202. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 206. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The one or more processor 202 along with the one or more memory modules 206 may operate as a controller for the first vehicle system 200.

The one or more memory modules 206 includes a machine learning (ML) model 207, a benefit score calculation module 209, and an edge encounter score calculation module 211. Each of the ML model 207, the benefit score calculation module 209, and the edge encounter score calculation module 211 may include, but not limited to, routines, subroutines, programs, objects, components, data structures, and the like for performing specific tasks or executing specific data types as will be described below.

The ML model 207 may by a machine learning model including, but not limited to, supervised learning models such as neural networks, decision trees, linear regression, and support vector machines, unsupervised learning models such as Hidden Markov models, k-means, hierarchical clustering, and Gaussian mixture models, and reinforcement learning models such as temporal difference, deep adversarial networks, and Q-learning.

The benefit score calculation module 209 calculates a benefit score for corresponding vehicle based on an energy for training the machine learning model of the vehicle and the value of training data used by the vehicle.

The edge encounter score calculation module 211 calculates an edge encounter score for corresponding vehicle based on the movement momentum of the vehicle and the direction from the location of the vehicle to one or more edge servers.

Referring still to FIG. 2, the first vehicle system 200 comprises one or more sensors 208. The one or more sensors 208 may include a forward facing camera installed in a vehicle. The one or more sensors 208 may be any device having an array of sensing devices capable of detecting radiation in an ultraviolet wavelength band, a visible light wavelength band, or an infrared wavelength band. The one or more sensors 208 may have any resolution. In some embodiments, one or more optical components, such as a mirror, fish-eye lens, or any other type of lens may be optically coupled to the one or more sensors 208. In embodiments described herein, the one or more sensors 208 may provide image data to the one or more processors 202 or another component communicatively coupled to the communication path 204. In some embodiments, the one or more sensors 208 may also provide navigation support. That is, data captured by the one or more sensors 208 may be used to autonomously or semi-autonomously navigate a vehicle. The first vehicle system 200 may detect external objects such as other vehicles using the one or more sensors 208.

In some embodiments, the one or more sensors 208 include one or more imaging sensors configured to operate in the visual and/or infrared spectrum to sense visual and/or infrared light. Additionally, while the particular embodiments described herein are described with respect to hardware for sensing light in the visual and/or infrared spectrum, it is to be understood that other types of sensors are contemplated. For example, the systems described herein could include one or more LIDAR sensors, radar sensors, sonar sensors, or other types of sensors for gathering data that could be integrated into or supplement the data collection described herein. Ranging sensors like radar sensors may be used to obtain a rough depth and speed information for the view of the first vehicle system 200.

The first vehicle system 200 comprises a satellite antenna 214 coupled to the communication path 204 such that the communication path 204 communicatively couples the satellite antenna 214 to other modules of the first vehicle system 200. The satellite antenna 214 is configured to receive signals from global positioning system satellites. Specifically, in one embodiment, the satellite antenna 214 includes one or more conductive elements that interact with electromagnetic signals transmitted by global positioning system satellites. The received signal is transformed into a data signal indicative of the location (e.g., latitude and longitude) of the satellite antenna 214 or an object positioned near the satellite antenna 214, by the one or more processors 202.

The first vehicle system 200 comprises one or more vehicle sensors 212. Each of the one or more vehicle sensors 212 is coupled to the communication path 204 and communicatively coupled to the one or more processors 202. The one or more vehicle sensors 212 may include one or more motion sensors for detecting and measuring motion and changes in motion of a vehicle, e.g., the vehicle 101. The motion sensors may include inertial measurement units. Each of the one or more motion sensors may include one or more accelerometers and one or more gyroscopes. Each of the one or more motion sensors transforms sensed physical movement of the vehicle into a signal indicative of an orientation, a rotation, a velocity, or an acceleration of the vehicle.

Still referring to FIG. 2, the first vehicle system 200 comprises network interface hardware 216 for communicatively coupling the first vehicle system 200 to the second vehicle system 220 and/or the edge server 110. The network interface hardware 216 can be communicatively coupled to the communication path 204 and can be any device capable of transmitting and/or receiving data via a network. Accordingly, the network interface hardware 216 can include a communication transceiver for sending and/or receiving any wired or wireless communication. For example, the network interface hardware 216 may include an antenna, a modem, LAN port, WiFi card, WiMAX card, mobile communications hardware, near-field communication hardware, satellite communication hardware and/or any wired or wireless hardware for communicating with other networks and/or devices. In one embodiment, the network interface hardware 216 includes hardware configured to operate in accordance with the Bluetooth® wireless communication protocol. The network interface hardware 216 of the first vehicle system 200 may transmit its data to the second vehicle system 220 or the edge server 110. For example, the network interface hardware 216 of the first vehicle system 200 may transmit vehicle data, location data, updated local model data and the like to the edge server 110.

The first vehicle system 200 may connect with one or more external vehicle systems (e.g., the second vehicle system 220) and/or external processing devices (e.g., the edge server 110) via a direct connection. The direct connection may be a vehicle-to-vehicle connection (“V2V connection”), a vehicle-to-everything connection (“V2X connection”), or a mm Wave connection. The V2V or V2X connection or mmWave connection may be established using any suitable wireless communication protocols discussed above. A connection between vehicles may utilize sessions that are time-based and/or location-based. In embodiments, a connection between vehicles or between a vehicle and an infrastructure element may utilize one or more networks to connect, which may be in lieu of, or in addition to, a direct connection (such as V2V, V2X, mmWave) between the vehicles or between a vehicle and an infrastructure. By way of non-limiting example, vehicles may function as infrastructure nodes to form a mesh network and connect dynamically on an ad-hoc basis. In this way, vehicles may enter and/or leave the network at will, such that the mesh network may self-organize and self-modify over time. Other non-limiting network examples include vehicles forming peer-to-peer networks with other vehicles or utilizing centralized networks that rely upon certain vehicles and/or infrastructure elements. Still other examples include networks using centralized servers and other central computing devices to store and/or relay information between vehicles.

Still referring to FIG. 2, the first vehicle system 200 may be communicatively coupled to the edge server 110 by the network 250. In one embodiment, the network 250 may include one or more computer networks (e.g., a personal area network, a local area network, or a wide area network), cellular networks, satellite networks and/or a global positioning system and combinations thereof. Accordingly, the first vehicle system 200 can be communicatively coupled to the network 250 via a wide area network, via a local area network, via a personal area network, via a cellular network, via a satellite network, etc. Suitable local area networks may include wired Ethernet and/or wireless technologies such as, for example, Wi-Fi. Suitable personal area networks may include wireless technologies such as, for example, IrDA, Bluetooth®, Wireless USB, Z-Wave, ZigBee, and/or other near field communication protocols. Suitable cellular networks include, but are not limited to, technologies such as LTE, WiMAX, UMTS, CDMA, and GSM.

Still referring to FIG. 2, the second vehicle system 220 includes one or more processors 222, one or more memory modules 226, one or more sensors 228, one or more vehicle sensors 232, a satellite antenna 234, and a communication path 224 communicatively connected to the other components of the second vehicle system 220. The components of the second vehicle system 220 may be structurally similar to and have similar functions as the corresponding components of the first vehicle system 200 (e.g., the one or more processors 222 corresponds to the one or more processors 202, the one or more memory modules 226 corresponds to the one or more memory modules 206, the one or more sensors 228 corresponds to the one or more sensors 208, the one or more vehicle sensors 232 corresponds to the one or more vehicle sensors 212, the satellite antenna 234 corresponds to the satellite antenna 214, the communication path 224 corresponds to the communication path 204, the network interface hardware 236 corresponds to the network interface hardware 216, the ML model 227 corresponds to the ML model 207, a benefit score calculation module 229 corresponds to the benefit score calculation module 209 and an edge encounter score calculation module 231 corresponds to the edge encounter score calculation module 211).

Still referring to FIG. 2, the edge server 110 includes one or more processors 242, one or more memory modules 246, network interface hardware 248, and a communication path 244. The one or more processors 242 may be a controller, an integrated circuit, a microchip, a computer, or any other computing device. The one or more memory modules 246 may comprise RAM, ROM, flash memories, hard drives, or any device capable of storing machine readable and executable instructions such that the machine readable and executable instructions can be accessed by the one or more processors 242. The one or memory modules 246 may store aggregated machine learning models received from representers and a global machine learning model. The machine readable and executable instructions, when executed by the one or more processors, aggregate the aggregated machine learning models received from representers to obtain the global machine learning model.

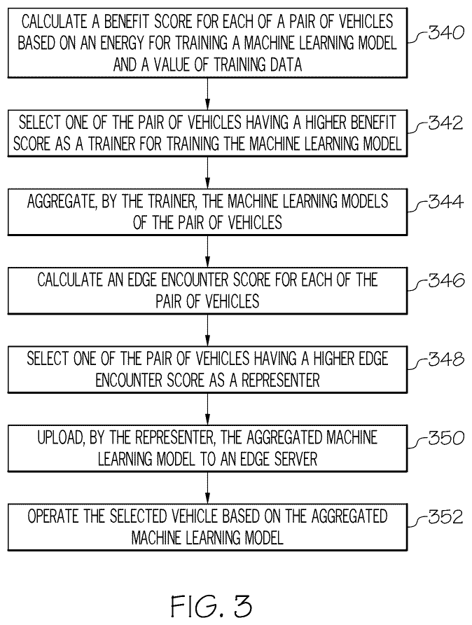

FIG. 3 depicts a flowchart for selecting a vehicle for training models and a vehicle for transmitting an aggregated model to an edge server between a pair of vehicles for decentralized machine learning, according to one or more embodiments shown and described herein. While FIG. 3 describes selecting between a pair of vehicles, the selection may be done among more than two vehicles.

In step 340, each vehicle calculates a benefit score for each of a pair of vehicles based on an energy required for training a machine learning model and a value of training data. By referring to FIG. 1A, for example, each of the vehicles 102 and 104 calculates a benefit score based on the energy for training corresponding machine learning model and the value of training data. The value of training data is related to how much the accuracy of the machine learning model is improved based on training using the training data. When a vehicle trains its machine learning model using training data, not all training improves the accuracy of the machine learning model. Whether the training improves the accuracy of the machine learning model or not depends on the value of the training data that are used to train the machine learning model and time required and available for training the machine learning model. The training data may be local data obtained by the sensors of corresponding vehicle or local data received from a nearby vehicle or an edge server. The energy for training data may consume the battery of the vehicle, which impacts battery electric vehicle range and efficiency. Thus, the benefit score increases as the value of training data increases and decreases as the energy for training corresponding machine learning model increases. That is, the benefit score is proportional to the value of training data, and is inversely correlated to the energy for training.

The benefit score B (X_{c}) is calculated using Equation 1 below.

$$B ( {X}_{c} ) = \frac{H ( {X}_{c} )}{{e}_{train}} \qquad Equation 1$$

Where X_{c} is the training data of vehicle c, H (X_{c}) is a Shannon entropy of the training data, and eₜᵣₐᵢₙ is energy for training a machine learning model using the training data. H (X_{c}) is calculated using Equation 2 below.

$$H ( {X}_{c} ) = - \sum P ( {x}_{i} ) log P ( {x}_{i} ) \qquad Equation 2$$

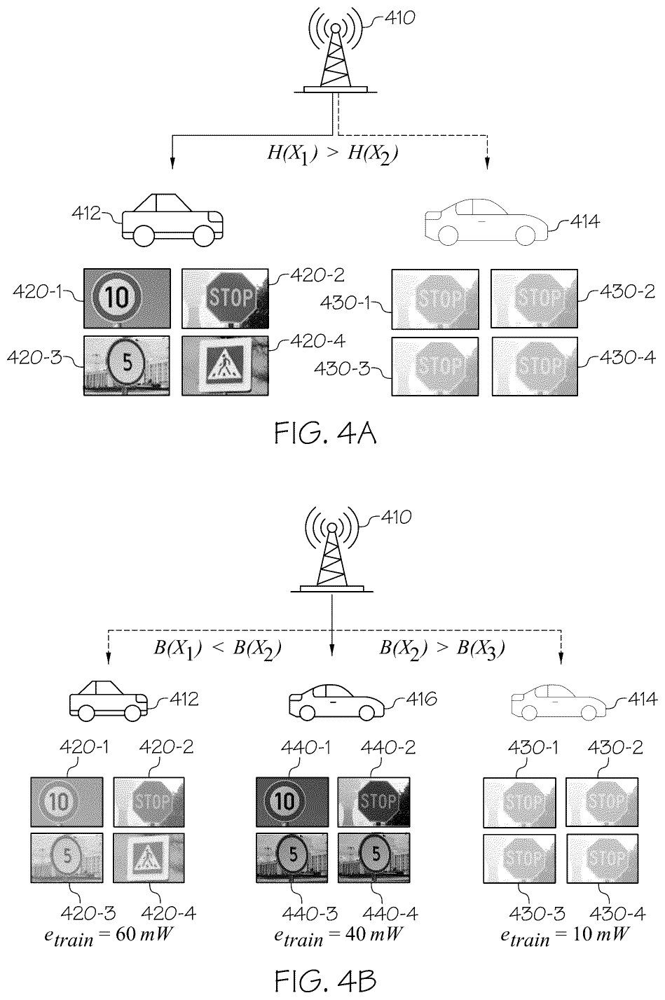

The training data X_{c} may be locally obtained by the vehicle c. For example, by referring to FIG. 4A, the training data include image data 420-1, 420-2, 420-3, 420-4 locally obtained by the vehicle 412. xᵢ is iₜₕ data in the training data X_{c}, such as the image data 420-1, 420-2, 420-3, or 420-4. P (xᵢ) is the probability of obtaining value xᵢ.

Once the benefit score is calculated, each of the pair of the vehicles share its benefit score with other vehicles.

The energy for training a machine learning model eₜᵣₐᵢₙ may be a rolling average of previous energies as in Equation 3 below.

$${e}_{train , t + 1} = \frac{{e}_{train , t - 1} + {e}_{train , t}}{2} \qquad Equation 3$$

Referring back to FIG. 3, in step 342, each vehicle selects one of the pair of vehicles having a higher benefit score as a trainer for training the machine learning model. For example, by referring to FIG. 1C, the vehicle 104 may have a higher benefit score than the vehicle 102 with respect to training its machine learning model using training data. Then, the vehicle 104 is selected as a trainer for training the machine learning model of the vehicle 104. Then, the vehicle 104 trains its machine learning model using the training data obtained by the vehicle 104. The vehicle 102 may not train its machine learning model because the benefit score of the vehicle 102 is lower than the benefit score of the vehicle 104. In some embodiments, the vehicle 102 may transmit its machine learning model to the vehicle 104. The vehicle 104 may train the machine learning model received from the vehicle 102 using the training data of the vehicle 104.

Referring back to FIG. 3, in step 344, the trainer aggregates the machine learning models of the pair of vehicles. In embodiments, by referring to FIG. 1C, the vehicle 104 as the trainer aggregates the machine learning models of the vehicles 102 and 104. The machine learning model of the vehicle 104 has been trained using training data of the vehicle 104 in step 342. The machine learning model of the vehicle 102 may have been also trained using training data of the vehicle 104 in step 342. The vehicle may aggregate the machine learning models of the vehicles 102 and 104, e.g., by federated averaging. The aggregation of the models may use different methods other than federated averaging. In some embodiments, the vehicle 104 may not train the machine learning model received from the vehicle 102, but aggregate the trained machine learning model of the vehicle 104 and the machine learning model received from the vehicle 102.

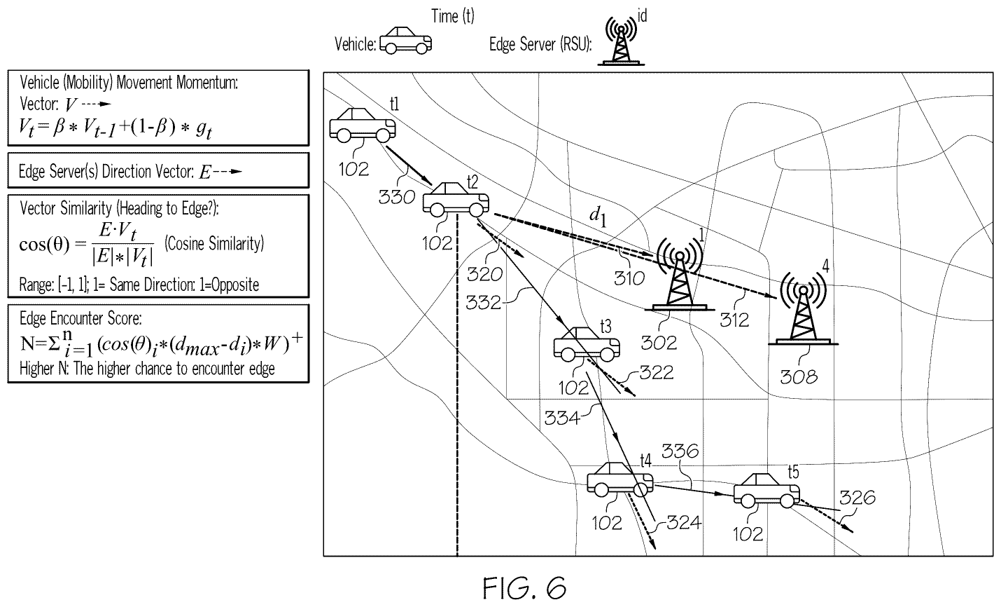

Referring back to FIG. 3, in step 346, each of the pair of vehicles obtains an edge encounter score for each of a pair of vehicles calculated based on a movement momentum of each of the pair of vehicles and a direction from a location of each of the pair of vehicles to each of one or more edge servers. By referring to FIGS. 1D, 5, and 6, the vehicle 102 calculates an edge encounter score for the vehicle 102 based on the movement momentum of the vehicle 102 and the direction from the location of the vehicle 102 to each of one or more edge servers (e.g., edge servers 302 and 308 in FIG. 6). Similarly, the vehicle 104 calculates an edge encounter score for the vehicle 104 based on a movement momentum of the vehicle 104 and a direction from a location of the vehicle 104 to each of one or more edge servers. The edge encounter score is represented in the following equation.

$$N = {\sum }_{i = 1}^{n} {( {( \frac{E \cdot {V}_{t}}{\vert E \vert * \vert {V}_{t} \vert} )}_{i} * ( {d}_{max} - {d}_{i} ) * W )}^{+} \qquad Equation 4$$

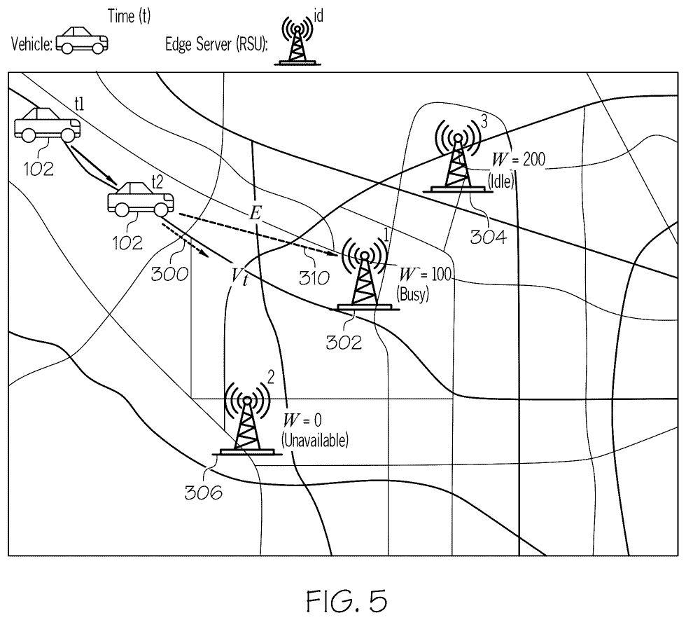

The parameter E is the direction of an edge server relative to the vehicle's current location. The parameter i denotes the iₜₕ edge server within the communication range of a given vehicle, e.g., the vehicle 102 in FIG. 5. dₘₐₓ is the maximum communication range of the vehicle 102. W is an edge weight, which is determined based on the current utilization rate of the edge server. For example, the value of W is inversely correlated to the current utilization rate of the edge server. By referring to FIG. 5, the status of the edge server 302 is busy and the status of the edge server 304 is idle. Because the edge server 304 has more resources to be utilized than the edge server 302, the value W of the edge server 304 is 200, which is higher than the value W of the edge server 302, which is 100. If an edge server is not available for computing, then the value of W may be 0. For example, in FIG. 5, the edge server 306 is not available for computing, and the value of W of the edge server 306 is 0.

Vₜ denotes the movement momentum for the vehicle 102. dᵢ is the distance from the vehicle to the iₜₕ edge server. The movement momentum as used in this disclosure does not carry the traditional physics-based definition. Instead, the movement momentum of the present disclosure aligns more closely with the concept of momentum utilized in machine learning optimization methods. The calculation for the movement momentum Vₜ is defined in the equation 5 below.

$${V}_{t} = β * {V}_{t - 1} + ( 1 - β ) * {g}_{t} \qquad Equation 5$$

Vₜ₋₁ represents the momentum from the previous time slot. The parameter β control the influence of the current internal motion gₜ and the movement momentum from the previous time slot (Vₜ₋₁) on the newly momentum (Vₜ). For example, when β is zero, only the present motion (gₜ) is taken into account, disregarding the past momentum (Vₜ₋₁). By referring to FIG. 6, if the current time is t₃, the movement momentum at t₃, V₃ 322, is calculated based on V₂ 320 and g₃ 334. Similarly, if the current time is t₂, the movement momentum at t₂, V₂ 320, is calculated based on V₁ (not shown in FIG. 6) and g₂ 332.

By leveraging both E and Vₜ, the present disclosure calculates the detection similarity between the edge server (E) and the vehicle's current momentum (Vₜ). This calculation utilizes the cosine similarity method, as shown in the equation 6 below.

$$cos ( θ ) = \frac{E \cdot {V}_{t}}{\vert E \vert * \vert {V}_{t} \vert} \qquad Equation 6$$

The outcome of the cosine similarity calculation ranges from −1 to 1. The outcome value of 1 indicates that the vehicle's movement momentum aligns exactly with the direction of the edge server. Conversely, the outcome value of −1 indicates the exact opposite direction. The outcome value of 0 denotes a right angle formation between the two vectors. In calculating the edge encounter score, the present disclosure only factors in edge servers that yield a positive cosine similarity value. This is because edge servers located in the opposite direction of the vehicle's momentum are not considered as candidates for uploading machine learning models.

Once each of the pair of vehicles calculates its edge encounter score, each shares the edge encounter score with the other vehicle. For example, by referring to FIG. 1D, the vehicle 102 calculates its edge encounter score as 7 and transmits the edge encounter score to the vehicle 104. Similarly, the vehicle 104 calculates its edge encounter score as 1 and transmits the edge encounter score to the vehicle 102.

Referring back to FIG. 3, in step 348, each of the pair of vehicles selects one of the pair of vehicles having a higher edge encounter score than other vehicle. For example, by referring to FIG. 1D, the controller of the vehicle 102 selects the vehicle 102 as a representer because the vehicle 102 has the edge encounter number of 7 which is greater than the edge encounter number of 1 of the vehicle 104. Then, the vehicle 102 may communicate the selection to the vehicle 104 such that the vehicle 104 transmits its machine learning model to the vehicle 102. In embodiments, the vehicle 104 was selected as a trainer and aggregated the machine learning models of the vehicles 102 and 104. Thus, the vehicle 104 transmits the aggregated machine learning model to the vehicle 102. In some embodiments, the controller of the vehicle 104 also selects the vehicle 102 as a representer because the vehicle 102 has the edge encounter number of 7 which is greater than the edge encounter number of 1 of the vehicle 104. Then, the vehicle 104 transmits its machine learning model to the vehicle 102.

Referring back to FIG. 3, in step 350, the selected vehicle uploads the aggregated machine learning model to one of the one or more edge servers. For example, by referring to FIG. 1D, the vehicle 102 uploads the aggregated machine learning model to the edge server 110 when the vehicle 102 is within the communication range of the edge server 110.

Referring back to FIG. 3, in step 352, the selected vehicle operates based on the aggregated machine learning model. For example, by referring to FIG. 1D, the vehicle 102 autonomously drives using the aggregated machine learning model. Similarly, the vehicle 104 may also autonomously drive using the aggregated machine learning model. In some embodiments, the vehicle 102 may receive a global machine learning model from the edge server 110 after uploading the aggregated machine learning model to the edge server 110. The edge server 110 may receive aggregated machine learning models from a plurality of representers, obtain the global machine learning model based on the received aggregated machine learning models, and transmit the global machine learning model to the vehicle 102. The vehicle 102 may autonomously drive using the global machine learning model. The vehicle 102 may share the global machine learning model with the vehicle 104.

FIG. 4A depicts comparing the value of training data between a pair of vehicles, according to one or more embodiments shown and described herewith.

In embodiments, a pair of vehicles 412 and 414 may be within a predetermined communication range with each other. Each of the pair of vehicles may determine the value of training data for training its machine learning data. The vehicle 412 may have training data including data 420-1, 420-2, 420-3, 420-4 that are obtained using, e.g., the sensors of the vehicle 412. The vehicle 414 may have training data 430-1, 430-2, 430-3, 430-4 that are obtained using, e.g., the sensors of the vehicle 414. The value of training data may be calculated using Equation 2 above. In this example, the training data of the vehicle 412 include more diverse images than the training data of the vehicle 414, and thus have higher entropy. Thus, the value H (X₁) of training data of the vehicle 412 is higher than the value H (X₂) of training data of the vehicle 414.

FIG. 4B depicts comparing benefit scores among multiple vehicles, according to one or more embodiments shown and described herewith. In embodiments, in addition to calculating the value of training data illustrated in FIG. 4A, the present disclosure considers energy for training machine learning models to calculate benefit scores.

Regarding the value of training data, the vehicle 412 may have training data including data 420-1, 420-2, 420-3, 420-4 that are obtained using, e.g., the sensors of the vehicle 412. The vehicle 414 may have training data 430-1, 430-2, 430-3, 430-4 that are obtained using, e.g., the sensors of the vehicle 414. The vehicle 416 may have training data 440-1, 440-2, 440-3, 440-4 that are obtained using, e.g., the sensors of the vehicle 416. The images of the training data of the vehicle 412 is most diverse among the vehicles 412, 414, 416, and the images of the training data of the vehicle 414 is most homogeneous. Thus, the value of training the machine learning of the vehicle 412 using the training data 420-1, 420-2, 420-3, 420-4 is the highest and the value of the training machine learning of the vehicle 414 using the training data 430-1, 430-2, 430-3, 430-4 is the lowest.

Regarding the energy for training machine learning models, the energy for training the machine learning model of the vehicle 412 using the training data 420-1, 420-2, 420-3, 420-4 is 60 mW. The energy for training the machine learning model of the vehicle 414 using the training data 430-1, 430-2, 430-3, 430-4 is 10 mW. The energy for training the machine learning model of the vehicle 416 using the training data 440-1, 440-2, 440-3, 440-4 is 40 mW. Then, the present disclosure calculates the benefit score B (X_{c}) for each of the vehicles 412, 414, 416 according to Equation 1 using the value of training data and the energy for training corresponding machine learning data. In this example, the vehicle 416 has the highest benefit score although the vehicle 412 has the highest value of training data and the vehicle 414 requires lowest energy for training its machine learning model. Then, the vehicle 416 is selected as a trainer for training its machine learning model using its training data.

FIG. 5 illustrates an exemplary scenario where a vehicle calculates an edge encounter score, according to one or more embodiments shown and described herein.

FIG. 5 illustrates the vehicle 102 at time t₁ and time t₂. At time t₂, the vehicle 102 may be within a communication range of each of edge servers 302, 304, 306. The status of the edge server 302 is busy, the status of the edge server 304 is idle, and the edge server 306 is not available for processing a machine leaning model. Then, the vehicle 102 calculates an edge encounter score with respect to the edge servers 302 and 304 using Equation 4 above. At time t₂, another vehicle, e.g., the vehicle 104 (not shown in FIG. 5) may be within a communication range of the vehicle 102, and calculate an edge encounter score with respect to the edge servers 302 and 304. Between the vehicle 102 and the vehicle 104, the vehicle that has a higher edge encounter score becomes a representer and aggregates the machine learning models of the vehicles 102 and 104.

FIG. 6 illustrates another exemplary scenario where a vehicle calculates an edge encounter score, according to another embodiments shown and described herein. FIG. 6 illustrates the vehicle 102 at different locations at different times t₁, t₂, t₃, t₄, t₅. At time t₂, two edge servers 302 and 308 are within the communication range of the vehicle 102. At time t₂, the movement momentum 320 of the vehicle 102 is Vₜ₂ and the present motion 332 is gₜ₂. There are two edge server direction vectors: E₁ and E₄. E₁ is a vector with respect to the edge server 302 and E₄ is a vector with respect to the edge server 308. Then, the vehicle 102 calculates the edge encounter score using Equation 4 above if the vehicle 102 encounters with another vehicle at time t₂.

If the vehicle 102 encounters another vehicle at time t₃, the vehicle 102 may calculate the edge encounter score at time t₃ using Equation 4. At time t₃, the movement momentum 322 of the vehicle 102 is Vₜ₃ and the present motion 334 is gₜ₃. There may be still two edge servers 302 and 308 available at time t₃, and the vehicle 102 may obtain edge server direction vectors for the edge servers 302 and 308. In a similar manner, the vehicle 102 may calculate an edge encounter score at time t₄ or t₅ if the vehicle 102 encounters with another vehicle at time t₄ or t₅.

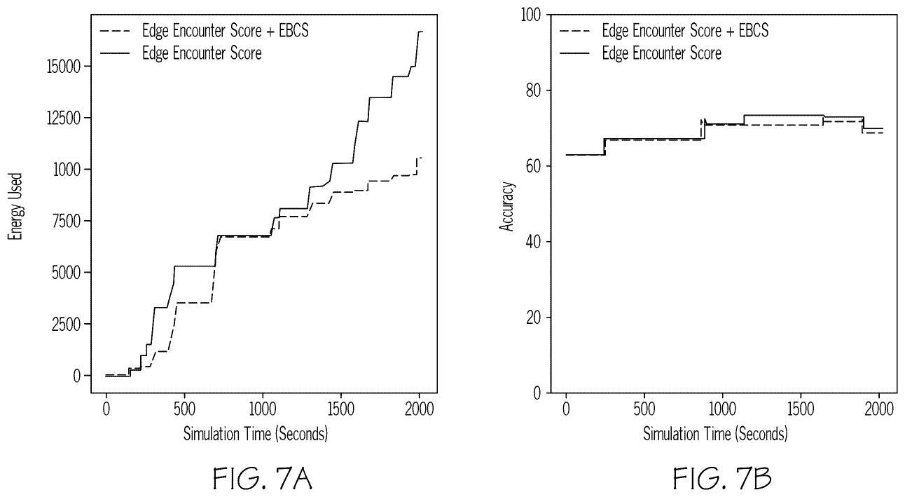

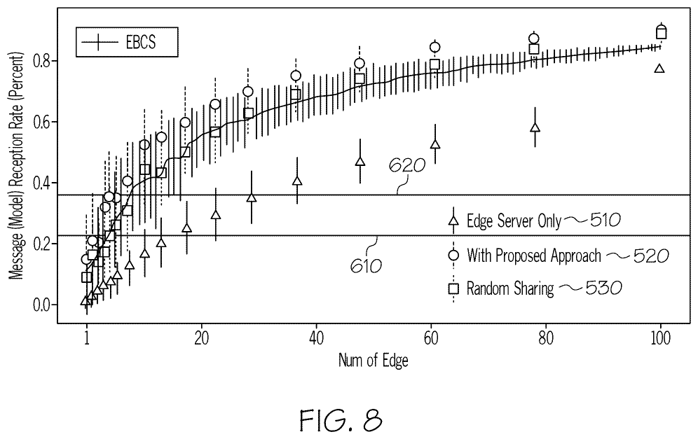

FIG. 7A depicts a test result showing a comparison of energy consumption between a model that utilizes an edge encounter score only and a model that utilizes an edge encounter score and a benefit score, or energy-balanced client selection.

The test uses a Simulation of Urban Mobility (SUMO) scenario with several thousand vehicles. Mobile edge computers (MECs) or edge servers are placed in different locations. Each vehicle participates in hybrid distributed machine learning (DML), and trains a convolutional neural network (CNN) on an image recognition task. When vehicles encounter one another, the vehicles use energy-balanced client section (EBCS) and edge encounter scores to decide which vehicle will act as a trainer to train the machine learning model and which vehicle will act as a representer to transmit an aggregated machine learning model to the MEC. EBCS utilizes the benefit score described above in selecting a client.

The present system utilizing the EBCS and the edge encounter score has superior energy consumption than a system that utilizes the edge encounter score only. That is, the present system allows EBCS to provide energy efficiency benefits to the system that utilizes the edge encounter score alone.

FIG. 7B depicts a test result showing a comparison of model accuracy between a model that utilizes an edge encounter score only and a model that utilizes an edge encounter score and an energy-balanced client selection.

The present system utilizing EBCS and the edge encounter score has comparable model training performance to the system that utilizes the edge encounter score alone. That is, utilizing both EBCS and the edge encounter score does not negatively affect model performance.

FIG. 8 depicts simulation result of message receptions rates, according to one or more embodiments shown and described herein. In FIG. 8, the X-axis represents the number of edge servers deployed in a simulated area, while the Y-axis indicates the percentage of messages or models received by these edge servers. Each dot in the results signifies the average message reception rate for a given number of edge servers, and the connecting line shows the standard deviation of these results.

The triangle results 510 were obtained with only edge servers without using edge encounter scores, while the circle results 520 were obtained using the approach of present disclosure that utilizes both benefit scores and edge encounter scores. The square results 530 were obtained using random sharing. As evident from the results, when compared to the performance with each number of edge servers, the circle results 520 of the present disclosure notably enhances the message or model reception rate more than doubling when the number of edge servers is relatively small.

Furthermore, when compared to square results 530, the random sharing approach where vehicles exchange messages without an edge encounter score based selection upon encountering each other and sending them to an edge server once they encounter one, the methodology of the present disclosure consistently outperforms.

When analyzing the results horizontally, the random sharing approach may match the performance of 15 edge servers by utilizing just 5 edge servers as depicted by the horizontal line 610. However, compared to the random sharing approach, the approach of the present disclosure can achieve the performance equivalent to 30 edge servers with merely 5 edge servers as illustrated by the horizontal line 620. This demonstration indicates that the methodology of the present disclosure enables at least an 83.33% reduction in edge server infrastructure. The methodology of the present disclosure provides a saving that is double when compared to the random sharing approach.

It should be understood that embodiments described herein are directed to a method for updating a machine learning model for vehicles using distributed machine learning. The method includes calculating a benefit score for each of a pair of vehicles based on an energy for training a machine learning model and a value of training data, selecting one of the pair of vehicles having a higher benefit score as a trainer for training the machine learning model, aggregating, by the trainer, the machine learning models of the pair of vehicles, calculating an edge encounter score for each of the pair of vehicles and selecting one of the pair of vehicles having a higher edge encounter score as a representer.

The present disclosure provides several advantages over conventional systems. The present disclosure reduces the cost of wide-scale deployment and the negative impacts to battery life. Specifically, the present disclosure implements DML with a minimal number of edge computers while providing the highest performance benefit with the lowest energy consumption. The present disclosure integrates edge encounter scores (EES) and energy-balanced client selection (EBCS) to provide hybrid DML at lower infrastructure cost, while consuming less energy on battery electric vehicles. The present disclosure reduces the number of mobile edge computers required for model aggregation and lowers the overall energy consumption of model training at the same time.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for updating a machine learning model for vehicles, the method comprising:
calculating a benefit score for each of a pair of vehicles based on an energy for training a machine learning model and a value of training data;
selecting one of the pair of vehicles having a higher benefit score as a trainer for training the machine learning model;
aggregating, by the trainer, the machine learning models of the pair of vehicles;
calculating an edge encounter score for each of the pair of vehicles;
selecting one of the pair of vehicles having a higher edge encounter score as a representer; and
uploading, by the representer, the aggregated machine learning model to an edge server.

2. The method of claim 1, wherein the value of training data is determined based on an entropy of the training data; and
the training data are a plurality of images captured by each of the pair of vehicles.

3. The method of claim 1, wherein the energy for training the machine learning model is a rolling average of previous energies.

4. The method of claim 1, further comprising:
operating the selected vehicle based on the aggregated machine learning model,
wherein the pair of vehicles are autonomous vehicles.

5. The method of claim 1, wherein the machine learning model is a convolutional neural network; and
the machine learning models of the pair of vehicles are aggregated by federated averaging.

6. The method of claim 1, wherein the edge encounter score for each of a pair of vehicles is calculated based on a movement momentum of each of the pair of vehicles and a direction from a location of each of the pair of vehicles to each of one or more edge servers.

7. The method of claim 6, wherein the edge encounter score for each of a pair of vehicles is calculated further based on a distance from the location of each of the pair of vehicles to each of the one or more edge servers.

8. The method of claim 6, wherein the edge encounter score for each of a pair of vehicles is calculated further based on utilization status of each of the one or more edge servers.

9. The method of claim 6, wherein the movement momentum of each of the pair of vehicles is calculated based on a weighted sum of a previous movement momentum and a current motion of corresponding vehicle.

10. The method of claim 1, further comprising:
identifying that each of one or more edge servers is within a predetermined distance of one of the pair of vehicles.

11. The method of claim 1, further comprising:
transmitting, by the selected vehicle, the aggregated machine learning model to the other vehicle.

12. The method of claim 1, wherein each of the pair of vehicles calculates corresponding edge encounter score and transmits corresponding edge encounter sore to the other vehicle.

13. A system for updating a machine learning model for vehicles, the system comprising:
a first vehicle comprising a first machine learning model and one or more processors; and
a second vehicle comprising a second machine learning model,
wherein the one or more processors are programmed to:
calculate a benefit score for the first vehicle based on an energy for training a machine learning model and a value of training data and obtain a benefit score for the second vehicle;
determine the first vehicle as a trainer for training the machine learning model based on a comparison of benefit scores of the first vehicle and the second vehicle;
aggregate the machine learning models of the first vehicle and the second vehicle;
calculate an edge encounter score for the first vehicle and obtain an edge encounter score for the second vehicle;
select one of the first vehicle and the second vehicle having a higher edge encounter score as a representer; and
instruct the representer to update the aggregated machine learning model to an edge server.

14. The system of claim 13, wherein the value of training data is determined based on an entropy of the training data; and
the training data are a plurality of images captured by each of the first vehicle and the second vehicle.

15. The system of claim 13, wherein the energy for training the machine learning model is a rolling average of previous energies.

16. The system of claim 13, wherein the edge encounter score for each of a pair of vehicles is calculated based on a movement momentum of each of the pair of vehicles and a direction from a location of each of the pair of vehicles to each of one or more edge servers.

17. The system of claim 16, wherein the edge encounter score for each of a pair of vehicles is calculated further based on a distance from the location of each of the pair of vehicles to each of the one or more edge servers.

18. A non-transitory computer readable medium storing instructions, when executed by one or more processors of a first vehicle, causing the one or more processors to:
calculate a benefit score for the first vehicle based on an energy for training a machine learning model and a value of training data and obtain a benefit score for a second vehicle;
determine the first vehicle as a trainer for training the machine learning model based on a comparison of benefit scores of the first vehicle and the second vehicle;
aggregate the machine learning models of the first vehicle and the second vehicle;
calculate an edge encounter score for the first vehicle and obtain an edge encounter score for the second vehicle;
select one of the first vehicle and the second vehicle having a higher edge encounter score as a representer; and
instruct the representer to update the aggregated machine learning model to an edge server.

19. The non-transitory computer readable medium of claim 18, wherein:
the value of training data is determined based on an entropy of the training data;
the training data are a plurality of images captured by each of the first vehicle and the second vehicle; and
the energy for training the machine learning model is a rolling average of previous energies.

20. The non-transitory computer readable medium of claim 18, wherein the edge encounter score for each of a pair of vehicles is calculated based on a movement momentum of each of the pair of vehicles and a direction from a location of each of the pair of vehicles to each of one or more edge servers.
